(19) United States
(12) Patent Application Publication
(10) Pub. No.: US 2013/0186251 A1
(43) Pub. Date: Jul. 25, 2013

(54) MAIN ACTION RAIL FOR UPRIGHT PIANO WITH FRONT-ACCESSIBLE WHIPPEN FLANGE SCREW

(71) Applicants: Kirk Burgett, Sacramento, CA (US); Jamie Marks, Haverhill, MA (US); Dana Mazzaglia, Haverhill, MA (US)

(72) Inventors: Kirk Burgett, Sacramento, CA (US); Jamie Marks, Haverhill, MA (US); Dana Mazzaglia, Haverhill, MA (US)

(21) Appl. No.: 13/354,251

(22) Filed: Jan. 19, 2012

(51) Int. Cl. G10C 3/16

(52) U.S. Cl. 84/242

(57) ABSTRACT

An upright piano main action rail with a thinner cross section and relocated lower front surface so that when the main action rail is installed an the upright piano, the lower front surface of upright piano main action rail resides in the same location as the lower rear surface of prior art upright piano main action rails. An upright piano main action rail also has all whippen mounting holes located on the lower front surface instead of the lower rear surface as is traditional.

### BACKGROUND OF THE INVENTION

1. Field of the Invention

This invention relates to upright piano actions, or more specifically the mechanisms in upright pianos that transmit motion from a piano player's fingers into motion of a hammer, located inside the piano, causing the hammer to strike a piano string, thereby producing sound or music from the piano. In every piano, there is a separate piano action and hammer corresponding to each piano key, where there are typically 88 keys in a piano. All piano actions and the hammers must be fastened to a stationary “rail” inside the piano in order to allow for proper motion of the piano actions subcomponents and cycling of the piano action. There is more than one rail in an upright piano, including the damper spring rail, the hammer rail, the main action rail, the let-off rail, the sticker rail, capstan rail, the balance rail, and the front rail. Typically, all rails run horizontally across the width of the piano, parallel to the row of piano keys on the piano. This invention deals with the “main action rail” of an upright piano.

2. Description of Related Art

Prior art main action rails for upright pianos include a design with whippen flange screw holes located on the rear or back of the piano action, where rear or back is defined as the side opposite the piano keys. With prior art main actions rails, the whippen flange screws are only accessible from the rear of the piano.

This poses a huge problem for piano technicians for logistical reasons because a great deal of work is required to gain access to the whippen flange screw located at the rear of the piano action. Periodically, for proper maintenance of the piano, replacement or repair of piano action subcomponents is required, thereby requiring the removal of whippens and whippen flanges from the piano.

To remedy this, the main action rail for upright piano of this invention includes a design with the whippen mounting holes located on the front of the main action rail, thereby providing front-access to all whippen flange screws, thereby greatly reducing the work required for technicians to remove the whippen assembly.

### BRIEF SUMMARY OF THE INVENTION

It is an aspect of this invention to provide a main action rail for an upright piano with front-mountable whippen flanges.

It is an aspect of this invention to provide a main action rail for an upright piano with a lower-front surface that is located at the same location as the lower-rear surface of prior art main action rails for upright pianos.

It is an aspect of this invention to provide a main action rail for an upright piano with a thinner cross-sectional design as compared to that in the prior art.

It is an aspect of this invention to provide a main action rail for an upright piano where the tapped holes for mounting the whippen flanges are located on the “front” surface of the main action rail and not on the “rear” surface of the main action rail.

It is an aspect of this invention to provide a main action rail for an upright piano with design that provides the ability to install all whippen flanges from the front of the piano action where the hinge pin or center pin in each whippen flange remains in the exact same location as those hinge or center pins in whippen flanges attached to prior art main action rails.

### BRIEF DESCRIPTION OF THE DRAWINGS

FIG. 1 is a right rear perspective view of a prior art main action rail depicting the whippen flange screw just prior to insertion of the whippen flange screw into the whippen flange mounting hole located on the rear of the main action rail and blow-up thereof.

FIG. 2 is a left rear perspective view of a prior art main action rail depicting the whippen flange screw just prior to insertion of the whippen flange screw into the whippen flange mounting hole located on the rear of the main action rail and blow-up thereof.

FIG. 3 is a right front perspective view of main action rail for upright piano with front-accessible whippen flange screw depicting the whippen flange screw after installation of the whippen flange screw into the whippen flange mounting hole located on the front of the main action rail and blow-up thereof.

FIG. 4 is a left front perspective view of main action rail for upright piano with front-accessible whippen flange screw depicting the whippen flange screw after installation of the whippen flange screw into the whippen flange mounting hole located on the front of the main action rail and blow-up thereof.

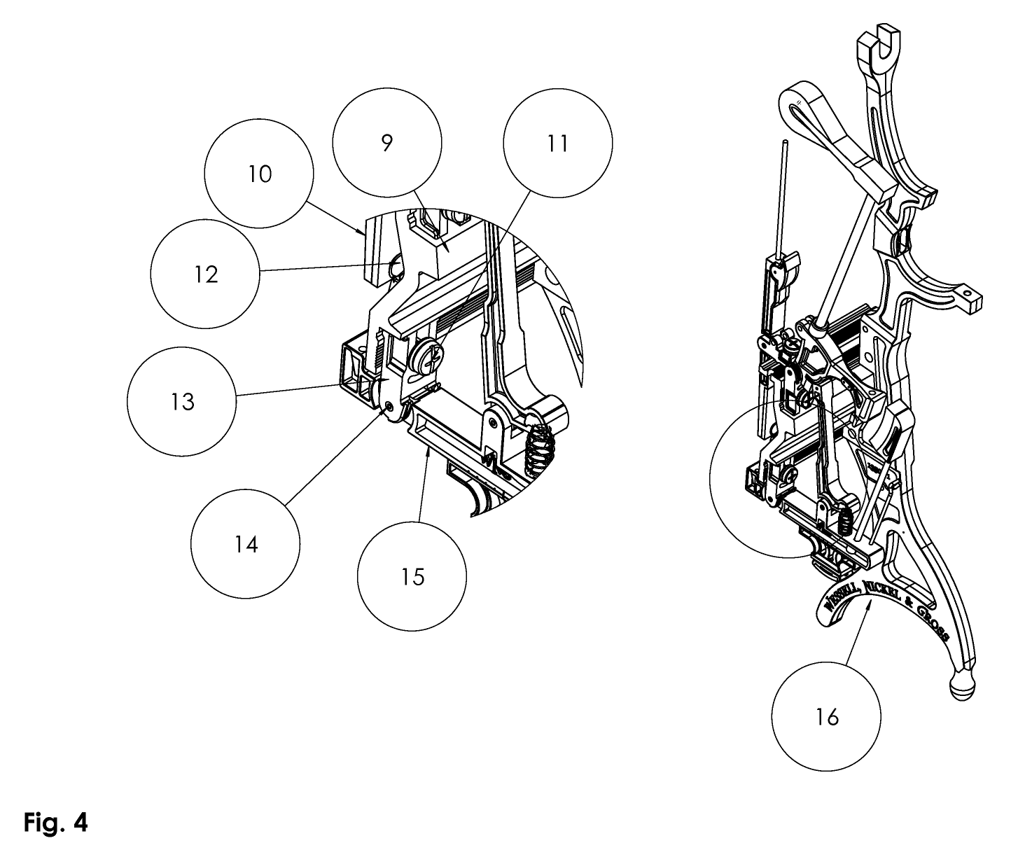

DEFINITION LIST

| Term | Definition |
|---|---|
| 1 | Prior Art Main Action Rail |
| 2 | Damper Lever |
| 3 | Whippen Flange Screw |
| 4 | Damper Spoon |
| 5 | Whippen Flange |
| 6 | Center Pin or Hinge Pin |
| 7 | Whippen |
| 8 | Back or Rear of Piano Action |
| 9 | Main Action Rail with Front-Accessible Whippen Flange Screw |
| 10 | Damper Lever |
| 11 | Whippen Flange Screw |
| 12 | Damper Spoon |
| 13 | Whippen Flange |
| 14 | Center Pin or Hinge Pin |
| 15 | Whippen |
| 16 | Front of Piano Action |

### DETAILED DESCRIPTION OF THE INVENTION

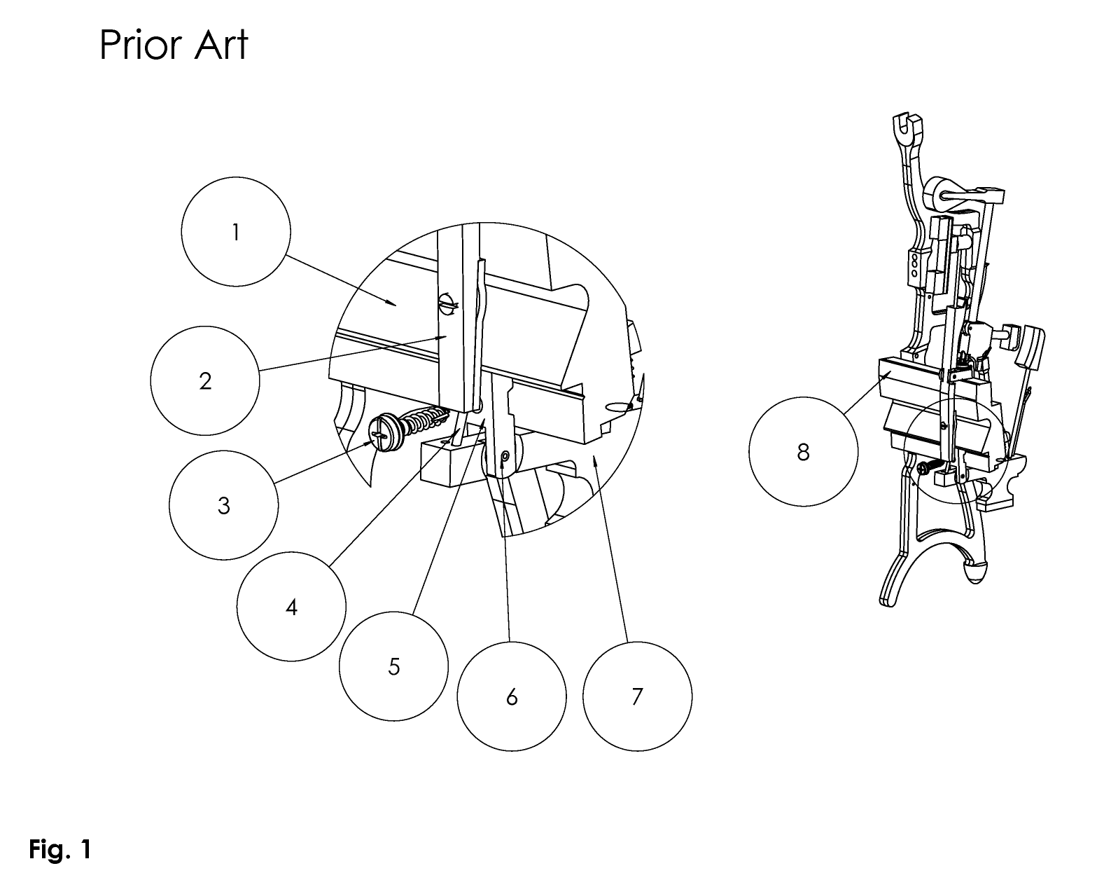

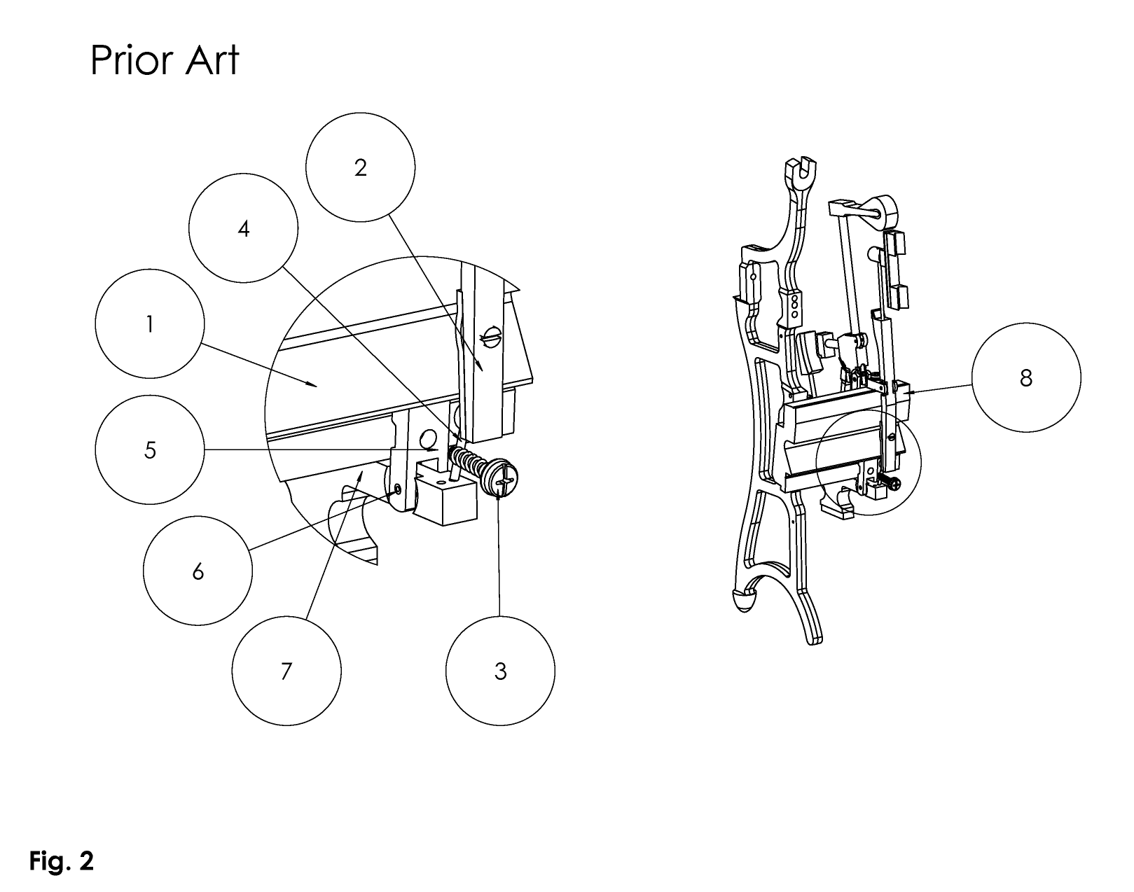

FIGS. 1 and 2 depict a prior art main action rail 1 for an upright piano. Main actions rails run horizontally across the entire width of the piano. All 88 whippens 7 and 88 whippen flanges 5 must be affixed or adhered to the main action rail 1. FIGS. 1 and 2 depict cut-away views of the main action rail 1, showing just one of the 88 piano actions and whippen assemblies of the piano. Depictions of main action rails 1 in FIGS. 1 and 2 are cut-away views of the full width of the main action rail 1.

Prior art main action rails 1 for upright pianos include a design where the tapped holes or mounting holes for the whippen flange are located on the rear or back 8 of the main action rail 1.

This poses a huge problem for piano technicians for logistical reasons because a great deal of work is required to gain access to the whippen flange screw 3 located at the rear of the piano action 8. Periodically, for proper maintenance of the piano, replacement or repair of piano action subcomponents is required, thereby requiring the removal of whippens 7 and whippen flanges 5 from the piano.

To remedy this, main action rail for upright pianos with front-accessible whippen flange screw 9 includes a design with location of the whippen mounting holes on the front of the main action rail 16, thereby providing front-access to all whippen flange screws 11, thereby greatly reducing the work required for technicians to remove the whippen flange 13 and whippen 15.

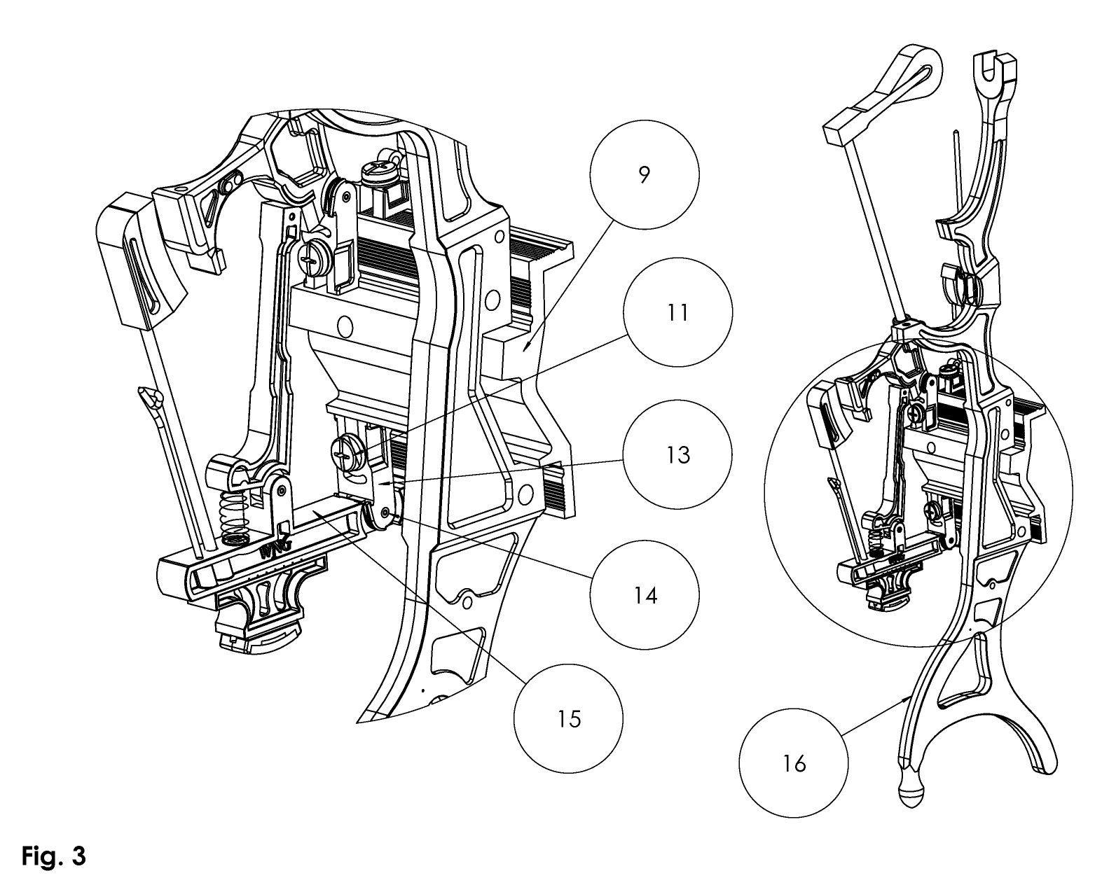

This is accomplished by the re-design of the cross-section of main action rail for upright pianos with front-accessible whippen flange screw 9. As can be seen from a comparison between FIGS. 1 and 3, we see that, in FIG. 3, with the new rail 9, the front surface of the new rail 9, into which whippen flange screw 11 is installed, has been “set-back” or moved backwards, as compared to the corresponding front surface of prior art rail 1 in FIG. 1. (Note that FIG. 1 depicts a back-view of the action, while FIG. 3 depicts a front-view of the action, so we must compare the surface depicted in FIG. 3 to the surface not depicted in FIG. 1.)

The location of each whippen flange 5 and 13 in each of FIGS. 1 and 3 remains constant, so that, in relation to the other action components, whippen flange 5 has the exact same location as whippen 13. More precisely, hinge pin 6 has the exact same location as hinge pin 14. The only difference in the flanges is that whippen flange 5 uses a whippen flange screw 3 entering from the rear 8, while whippen flange 13 uses a whippen flange screw 11 entering from the front 16. This aspect provides the ability for main action rail for upright pianos with front-accessible whippen flange screw 9 to be compatible with prior art piano action components.

What is claimed:

1. An upright piano main action rail wherein said upright piano main action rail has a thinned cross section as compared to that of a traditional upright piano main action rail and a relocated lower front surface so that the lower front surface of said upright piano main action rail is positioned where the rear lower surface of a traditional upright piano main action rail would be.

2. An upright piano main action rail as recited in clam 1 wherein all tapped holes used to mount whippen flanges are located on the front lower surface of said upright piano main action rail.
